(19) United States
(12) Patent Application Publication
(10) Pub. No.: US 2015/0234233 A1
(43) Pub. Date: Aug. 20, 2015

(54) BACKLIGHT APPARATUS

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: ZHI-MING ZHU, Wuhan (CN); MING-HUI LUO, Wuhan (CN); TING WANG, Wuhan (CN)

(21) Appl. No.: 14/524,665

(22) Filed: Oct. 27, 2014

(30) Foreign Application Priority Data
Feb. 15, 2014 (CN) 2014100513318

(51) Int. Cl. G02F 1/1335; F21V 8/00

(52) U.S. Cl. CPC G02F 1/133608; G02F 1/133605; G02F 1/133606; G02B 6/0033; G02F 2001/133612

(57) ABSTRACT

Backlight apparatus includes a backlight module. The backlight module includes a light member, a light guiding member, a baffle-board and an astigmatism board. The light guiding member is used to guide lights or direct lights emitted by the light member and includes a first guiding surface and a second guiding surface. The baffle-board is attached to the first guiding surface, and the astigmatism board is adhered to the second guiding surface. The lights extending through the first guiding surface is reflected back to the light guiding member by the baffle-board for increasing the brightness of the light guiding member, and the direct lights extending through the second guiding surface is changed to diffused lights by the astigmatism board for allowing the backlight module to be seen in different views.

### FIELD

The present disclosure relates to backlight apparatuses.

### BACKGROUND

Many display devices, such as liquid crystal displays (LCDs) or digital micro-mirror devices (DMDs), use light valves which are backlit, side-lit or front-lit. In a backlit light valve display, such as an LCD, a backlight is positioned behind a liquid crystal panel. The backlight radiates light through the LC panel, which modulates the light to register an image.

### BRIEF DESCRIPTION OF THE DRAWINGS

Implementations of the present technology will now be described, by way of example only, with reference to the attached figures.

FIG. 1 is an exploded, isometric view of a backlight apparatus in accordance with an embodiment.

FIG. 2 is an exploded, isometric view of a backlight module of the backlight of FIG. 1.

FIG. 3 is assembled view of the backlight apparatus of FIG. 1.

FIG. 4 is a cross-section view of FIG. 3, take along a line IV-IV.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

The present disclosure is described in relation to a backlight apparatus comprising a backlight module. The backlight module comprises a light member, a light guiding member, a baffle-board and an astigmatism board. The light guiding member is used to guide lights or direct lights emitted by the light member and comprises a first guiding surface and a second guiding surface opposite to the first guiding surface. The baffle-board is attached to the first guiding surface, and the astigmatism board is adhered to the second guiding surface. The lights extending through the first guiding surface is reflected back to the light guiding member by the baffle-board for increasing the brightness of the light guiding member, and the direct lights extending through the second guiding surface is changed to diffused lights by the astigmatism board for allowing the backlight module to be seen in different views.

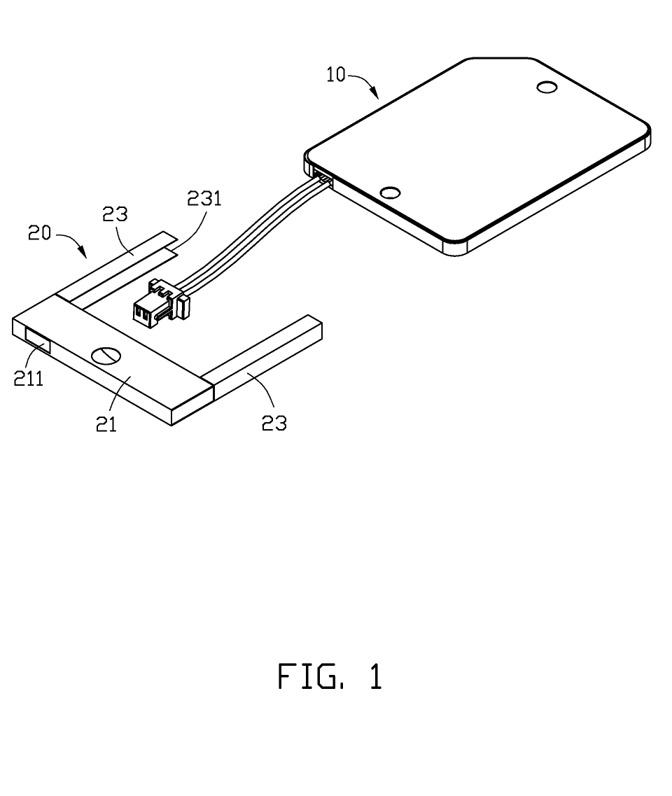

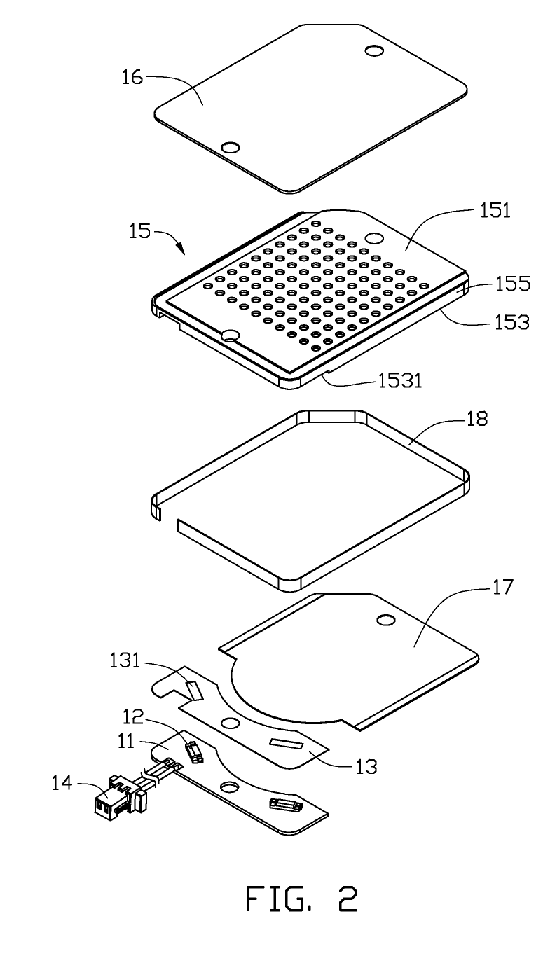

FIGS. 1-2 illustrate an embodiment of a backlight apparatus. The backlight apparatus comprises a backlight module 10 and a mounting tray 20. The backlight module 10 can be slidably received in the mounting tray 20. In at least one embodiment, the backlight apparatus can be secured to a LOGO of an electronic device (not shown) for showing the LOGO, and the electronic device can be an All-In-One.

The backlight module 10 can comprises a circuit board 11, two light members 12, a securing panel 13, a connecting member 14, a light guiding member 15, a baffle-board 16, an astigmatism board 17, and a shielding member 18. The two light members 12 are coupled to the circuit board 11 for emitting lights. In at least one embodiment, the two light members 12 are symmetric set on the circuit board 11, so that the lights from the two light members 12 are evenly. Each light member 12 can be a light emitting diode. A first end of the connecting member 14 is connected to the circuit board 11, a second end of the connecting member 14 can be connected to a motherboard (not shown) in the electronic device, such that the motherboard can supply power for the circuit board 11. The securing panel 13 can be adhered to the circuit board 11. Two through holes 131, for allowing the two light members 12 to extend through, are defined in the securing panel 13.

The light guiding member 15 is used to guide the lights emitted by the two light members 12 and comprises a first guiding surface 151, a second guiding surface 153 opposite to the first guiding surface 151, and two side surfaces 155 coupled to the first guiding surface 151 and the second guiding surface 153. A receiving portion 1531 is defined in the second guiding surface 153 for attaching the two light members 12. In at least one embodiment, the light guiding member 15 is semitransparent. The baffle-board 16 can press fit on the first guiding surface 151, so that lights extending through the first guiding surface 151 can be reflected back to the light guiding member 15 for increasing the brightness of the light guiding member 15. The astigmatism board 17 can be adhered to the second guiding surface 153, so that direct lights extending through the second guiding surface 153 can be changed to diffused lights for allowing the backlight module to be seen in different views. The shielding member 18 can be secured to the four side surfaces 155 for prevent the lights extending through the four side surfaces 155 from emitting out of the guiding member 15.

The mounting tray 20 comprises a frame 21 and two side portions 23 extending from opposite sides of the frame 21. An opening 211 is defined in the frame 21, and the connecting member 14 can extend through the opening 211. Each side portion 23 is substantially U-shaped to form a sliding passage 231, and opposite sides of the backlight module 10 can be slidably received in the sliding passages 231 and then the backlight module 10 can be slid relative to the mounting tray 20.

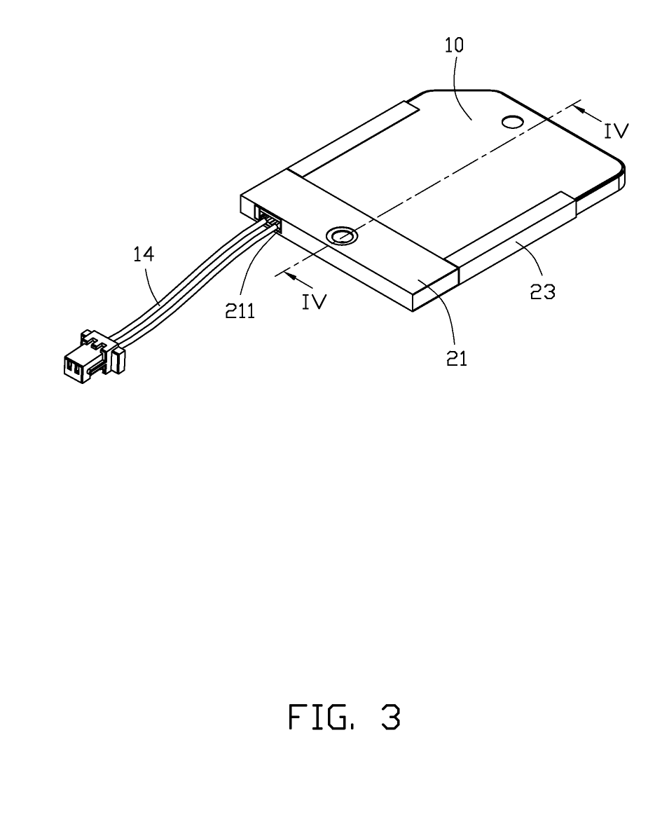

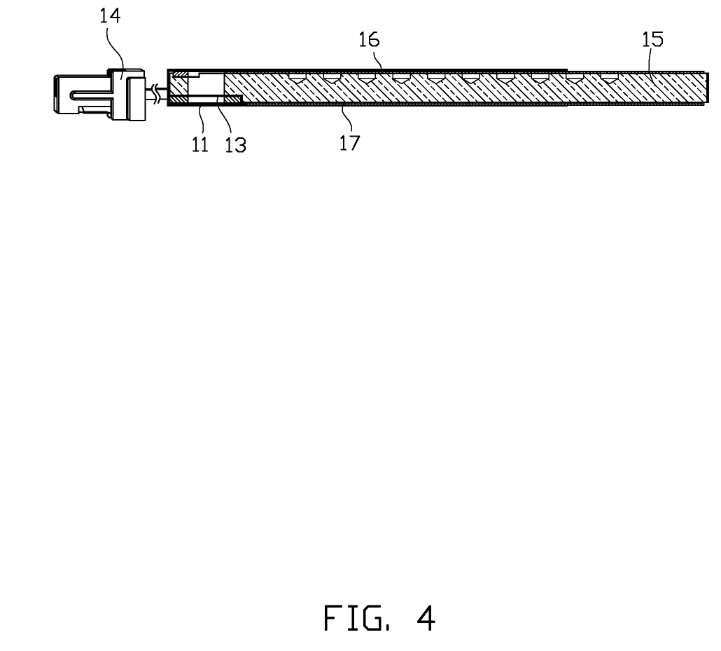

FIGS. 3-4 illustrate an assembly of the backlight apparatus. The securing panel 13 is secured to the circuit board 11 and the two light members 12 extend through the two through holes 131. The securing panel 13 is received in the receiving portion 1531 for allowing the two light members 12 attached to the guiding member 15. The baffle-board 16 presses fit on the first guiding surface 151, the astigmatism board 17 is adhered to the second guiding surface 153, and the shielding member 18 is secured to the four side surfaces 155. The opposite sides of the backlight module 10 are slidably received in corresponding sliding passages 231, and an end of the backing module 10 is received in the frame 20 to slidably secure the backlight module 10 to the mounting tray 10. The connecting member 14 extends from the opening 211.

In use, the connecting member 14 is connected to the motherboard of the electronic device, so that the motherboard can supply power for the circuit board 11 to light the two light members 12. The light emitted by the two light members 12 can emit into the light guiding member 15. Lights extending through the first guiding surface 151 are reflected back to the light guiding member 15 by the baffle-board 16 for increasing the brightness of the light guiding member 15. Lights extending through the second guiding surface 153 are changed to diffused lights by the astigmatism board 17 for allowing the backlight module 10 to be seen in different views. Lights extending through the four side surfaces 155 are prevent by the shielding member 18 from emitting out of the guiding member 15.

The embodiments shown and described above are only examples. Many details are often found in the art such as the other features of a circuit board. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A backlight apparatus comprising:
a backlight module comprising a light member configured to emit lights or direct lights, a light guiding member, a baffle-board and an astigmatism board; the light guiding member is configured for guiding lights or direct lights and comprises a first guiding surface and a second guiding surface opposite to the first guiding surface; the baffle-board is attached to the first guiding surface, and the astigmatism board is adhered to the second guiding surface;
wherein the lights extending through the first guiding surface is reflected back to the light guiding member by the baffle-board for increasing the brightness of the light guiding member, and the direct lights extending through the second guiding surface is changed to diffused lights by the astigmatism board for allowing the backlight module to be seen in different views.

2. The backlight apparatus of claim 1, wherein the light guiding member further comprise four side surfaces connected to the first guiding surface and the second guiding surface, and the backlight module further comprises a shielding member attached to the four side surfaces.

3. The backlight apparatus of claim 1, wherein the backlight further comprises a circuit board, and the light member is located on the circuit board.

4. The backlight apparatus of claim 3, wherein a connecting member is connected to the circuit board, and the connecting member is configured to connect a motherboard of an electronic device for receiving power from the motherboard.

5. The backlight apparatus of claim 3, wherein the backlight module further comprises a securing panel attached to the circuit board, and the securing panel defines a through hole for the light member extending through.

6. The backlight apparatus of claim 5, wherein the light guiding member defines a receiving portion, and the securing panel and the circuit board are received in the receiving portion.

7. The backlight apparatus of claim 1, further comprising a mounting tray, wherein the backlight module is slidably attached to the mounting tray.

8. The backlight apparatus of claim 7, wherein the mounting tray comprises a frame and two side portions, each side portion defines a slide passage, and the backlight module is slidably received in the slide passages.

9. A backlight apparatus comprising:
a mounting tray;
a backlight module slidably attached to the mounting tray and comprising a light member configured to emit lights, a light guiding member, and a baffle-board; the light guiding member configured for guiding lights emitted by the light member and comprising a first guiding surface; the baffle-board is attached to the first guiding surface;
wherein the lights extending through the first guiding surface is reflected back to the light guiding member by the baffle-board for increasing the brightness of the light guiding member.

10. The backlight apparatus of claim 9, wherein the light member is further configured to emit direct lights, the light guiding member further comprises a second guiding surface opposite to the first guiding surface, the backlight module further comprises an astigmatism board adhered to the second guiding surface, and the direct lights extending through the second guiding surface is changed to diffused lights by the astigmatism board for allowing the backlight module to be seen in different views.

11. The backlight apparatus of claim 10, wherein the light guiding member further comprise four side surfaces connected to the first guiding surface and the second guiding surface, and the backlight module further comprises a shielding member attached to the four side surfaces. 12. The backlight apparatus of claim 9, wherein the backlight further comprises a circuit board, and the light member is located on the circuit board.

13. The backlight apparatus of claim 12, wherein a connecting member is connected to the circuit board, and the connecting member is configured to connect a motherboard of an electronic device for receiving power from the motherboard.

14. The backlight apparatus of claim 13, wherein the mounting tray comprises a frame and two side portions, each side portion defines a slide passage, and the backlight module is slidably received in the slide passages.

15. The backlight apparatus of claim 14, wherein an opening is defined in the frame, and the connecting member extends through the opening.

16. The backlight apparatus of claim 12, wherein the backlight module further comprises a securing panel attached to the circuit board, and the securing panel defines a through hole for the light member extending through.

17. The backlight apparatus of claim 16, wherein the light guiding member defines a receiving portion, and the securing panel and the circuit board are received in the receiving portion.
